(19) United States
(12) Patent Application Publication
(10) Pub. No.: US 2013/0297400 A1
(43) Pub. Date: Nov. 7, 2013

(54) OFFER MODIFICATION BASED ON CIRCUMSTANCES

(71) Applicants: Srinath NAGARAJAN, Charlotte, NC (US); Matthew Laine DONLAN, Charlotte, NC (US); Tushar SHAH, Charlotte, NC (US)

(72) Inventors: Srinath NAGARAJAN, Charlotte, NC (US); Matthew Laine DONLAN, Charlotte, NC (US); Tushar SHAH, Charlotte, NC (US)

(73) Assignee: Bank of America Corporation, Charlotte, NC (US)

(21) Appl. No.: 13/528,478

(22) Filed: Jun. 20, 2012

Related U.S. Application Data
(60) Provisional application No. 61/641,662, filed on May 2, 2012.

(51) Int. Cl. G06Q 30/02

(52) U.S. Cl. 705/14.35

(57) ABSTRACT

Embodiments of the invention are directed to systems, methods and computer program products for modifying an offer having an initial offer value including the steps of determining a first time associated with initial offer acceptance, determining a period of time corresponding to a life of the offer, initiating a clock counting down the period of time, receiving a communication indicated that the offer has been redeemed, determining a second time associated with offer redemption, and calculating, in response to receiving the communication, a modified offer value based on the first time, the second time, the initial offer value and the life of the offer.

### CLAIM OF PRIORITY UNDER 35 U.S.C. §119

This Non-provisional patent application claims priority to Provisional Patent Application Ser. No. 61/641,662 titled “OFFER MODIFICATION BASED ON CIRCUMSTANCES” filed on May 2, 2012, assigned to the assignee hereof and hereby expressly incorporated by reference herein.

### BACKGROUND

When an entity sends a targeted purchase offer to a potential customer, there is a greater likelihood that the potential customer actually takes advantage of the purchase offer. However, even when offers are targeted, sometimes customers forget to activate and/or redeem the offers in a timely fashion. Thus, both the customer and the merchant potentially lose the benefit of the offer being redeemed. There is a need, therefore, for additional incentives for a customer to activate and redeem offers, rather targeted or generic in nature.

### BRIEF SUMMARY

Embodiments of the invention are directed to systems, methods and computer program products for modifying an offer having an initial offer value including the steps of determining a first time associated with initial offer acceptance, determining a period of time corresponding to a life of the offer, initiating a clock counting down the period of time, receiving a communication indicated that the offer has been redeemed, determining a second time associated with offer redemption, and calculating, in response to receiving the communication, a modified offer value based on the first time, the second time, the initial offer value and the life of the offer.

According to embodiments of the invention, a system for modifying an offer having an initial offer value has a processing device and a non-transient computer-readable memory storing computer-executable instruction code to cause the processing device to determine a first time associated with initial offer acceptance, determine a period of time corresponding to a life of the offer, initiate a clock counting down the period of time, receive a communication indicating that the offer has been redeemed, determine a second time associated with offer redemption and calculate, in response to receiving the communication, a modified offer value based on at least one of the first time, the second time, the initial offer value and the life of the offer. In some embodiments, the instruction code is further structured to cause the processing device to credit a user's account used in a transaction wherein the offer was redeemed, the crediting based at least in part on the calculated modified offer value. In some embodiments, the instruction code is further structured to cause the processing device to receive input from a user activating the offer, thereby initiating the clock counting down the period of time and wherein the first time associated with initial offer acceptance is based at least in part on the activation of the offer. In some embodiments, the instruction code is further structured to cause the processor to initiate a communication to the user to inform the user of the modified offer value. In some embodiments, the modified offer value comprises a value of one or more additional offers. In some embodiments, the instruction code is further structured to cause the processor to determine that the user has performed a predetermined social media task; and present the user with the offer for potential acceptance and redemption. In some embodiments, the instruction code is further structured to cause the processor to determine that the second time associated with offer redemption falls within a predetermined window of time associated with a special offer value and calculate, in response to receiving the communication that the offer has been redeemed, the modified offer value based at least in part on the special offer value.

According to embodiments of the invention, a computer program product for modifying an offer having an initial offer value has a non-transitory computer-readable medium comprising a set of codes for causing a computer to determine a first time associated with initial offer acceptance, determine a period of time corresponding to a life of the offer, initiate a clock counting down the period of time, receive a communication indicating that the offer has been redeemed, determine a second time associated with offer redemption, and calculate, in response to receiving the communication, a modified offer value based on the first time, the second time, the initial offer value and the life of the offer.

In some embodiments, the set of codes is further for causing a computer to credit a user's account used in a transaction wherein the offer was redeemed, the crediting based at least in part on the calculated modified offer value. In some embodiments, the set of codes is further for causing a computer to receive input from a user activating the offer, thereby initiating the clock counting down the period of time and wherein the first time associated with initial offer acceptance is based at least in part on the activation of the offer. In some embodiments, the set of codes is further for causing a computer to initiate a communication to the user to inform the user of the modified offer value. In some embodiments, the modified offer value comprises a value of one or more additional offers. In some embodiments, the set of codes is further for causing a computer to determine that the user has performed a predetermined social media task; and present the user with the offer for potential acceptance and redemption. In some embodiments, the set of codes is further for causing a computer to determine that the second time associated with offer redemption falls within a predetermined window of time associated with a special offer value; and calculate, in response to receiving the communication that the offer has been redeemed, the modified offer value based at least in part on the special offer value.

According to embodiments of the invention, a method for modifying an offer having an initial offer value includes providing a computer processor executing computer-readable code structured to cause the computer processor to determine a first time associated with initial offer acceptance, determine a period of time corresponding to a life of the offer, initiate a clock counting down the period of time, receive a communication indicating that the offer has been redeemed, determine a second time associated with offer redemption, and calculate, in response to receiving the communication, a modified offer value based on the first time, the second time, the initial offer value and the life of the offer.

In some embodiments, the code is further structured to cause the computer processor to credit a user's account used in a transaction wherein the offer was redeemed, the crediting based at least in part on the calculated modified offer value. In some embodiments, the code is further structured to cause the computer processor to receive input from a user activating the offer, thereby initiating the clock counting down the period of time and wherein the first time associated with initial offer acceptance is based at least in part on the activation of the offer. In some embodiments, the code is further structured to cause the computer processor to initiate a communication to the user to inform the user of the modified offer value. In some embodiments, the modified offer value comprises a value of one or more additional offers. In some embodiments, the code is further structured to cause the computer processor to determine that the user has performed a predetermined social media task and present the user with the offer for potential acceptance and redemption. In some embodiments, the code is further structured to cause the computer processor to determine that the second time associated with offer redemption falls within a predetermined window of time associated with a special offer value and calculate, in response to receiving the communication that the offer has been redeemed, the modified offer value based at least in part on the special offer value.

### BRIEF DESCRIPTION OF THE DRAWINGS

Having thus described embodiments of the invention in general terms, reference will now be made to the accompanying drawings, where:

FIG. 1 is a flowchart illustrating a general process flow for implementing rule-based offer association, in accordance with embodiments of the present invention;

FIG. 2 is a flowchart illustrating a general process flow for queuing input information for performing rule-based offer association, in accordance with embodiments of the present invention;

FIG. 3 is a flowchart illustrating a general process flow for implementing an intelligent offer tool, in accordance with embodiments of the present invention;

FIG. 4 is a block diagram illustrating technical components of a system for implementing the various processes described herein, in accordance with embodiments of the present invention; and

FIG. 5 is a flowchart illustrating a general process flow for implementing an offer modification based on circumstances, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for implementing rule-based offer association and queuing input information for performing rule-based offer association, and an offer tool for determining whether to present an offer to a user. The invention enables an entity to send targeted offers to a user that enables the user to receive at least one of a discount or a rebate on a purchase from a third-party merchant.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, etc.) at the entity) or potential customer (e.g., a person who has submitted an application for an account, a person who is the target of marketing materials that are distributed by the entity, a person who applies for a loan that not yet been funded).

As an example, an entity (e.g., a financial institution) may send an offer to a user (e.g., an account holder). The offer may be presented the user via at least one of the user's electronic banking account (e.g., online banking account, mobile banking account, etc.), the user's social network account, email, or text message. In some embodiments, the user may select an option associated with the presented offer to accept the offer. When the user accepts the offer, the offer is activated so that if the user uses an eligible payment method (as determined by the entity or the merchant) to make a purchase associated with the offer, the user receives the benefit associated with the offer. In other embodiments, the offer may be automatically activated if the user has previously chosen to automatically activate offers associated with particular types (e.g., associated with particular merchants or product or service types). In some embodiments, the entity or the merchant may determine that a user may choose among multiple eligible payment methods in order to make a purchase associated with the offer.

As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, etc.). When the transaction is processed by the financial institution at a predetermined time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

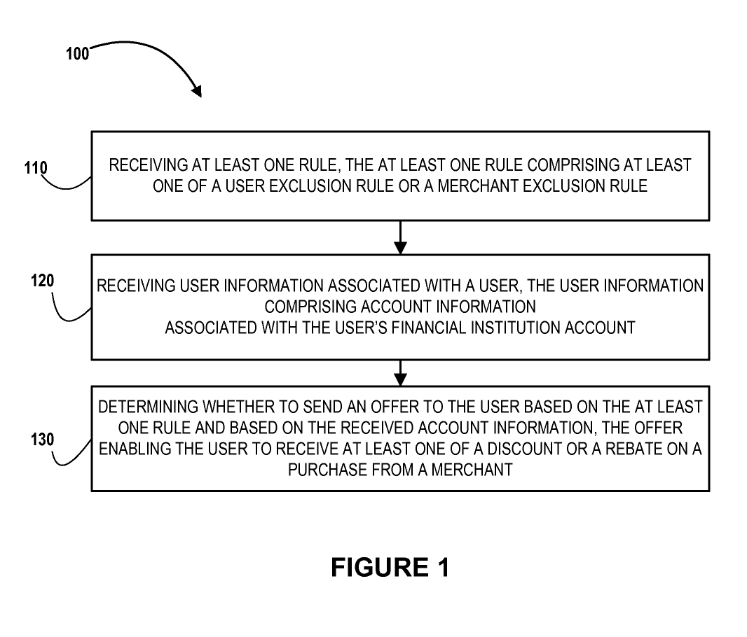

Referring now to FIG. 1, a general process flow 100 is provided for implementing rule-based offer association. At block 110, the method comprises receiving at least one rule, the at least one rule comprising at least one of a user exclusion (or user filtering) rule or a merchant exclusion (or merchant filtering) rule. At block 120, the method comprises receiving user information associated with a user, the user information comprising account information associated with the user's financial institution account. At block 130, the method comprises determining whether to send an offer to the user based on the at least one rule and based on the received user information, the offer enabling the user to receive at least one of a discount or a rebate on a purchase from a merchant. As described previously, in some embodiments, the discount or rebate is received at a point of time in the future when the transaction that qualifies for the offer is processed by the financial institution.

In some embodiments, account information, as used herein, refers to information associated with the user's financial institution account(s) managed by a single financial institution. In other embodiments, account information may refer to information associated with the user's financial institution accounts managed by multiple distinct financial institutions.

As used herein, a user exclusion rule is a rule that excludes some users from receiving offers. In some embodiments, the at least one user exclusion rule comprises an affinity exclusion rule. Therefore, if the financial institution already has an existing relationship (e.g., for providing or sending offers associated with a particular merchant) with some users via an affinity program, those users are excluded from receiving an offer. In some embodiments, the at least one user exclusion rule comprises a risk exclusion rule. Therefore, if a user is determined to be a risky user (e.g., has a credit score lower than a predetermined threshold), the user is excluded from receiving an offer. In some embodiments, the at least one user exclusion rule comprises an account exclusion rule. Therefore, for example, if a user's account has a balance (or another account characteristic) that is lower than predetermined threshold, the user is excluded from receiving an offer.

In some embodiments, a merchant exclusion rule is a rule that excludes some merchants from providing offers to users associated with the financial institution. In some embodiment, the at least one merchant exclusion rule comprises a merchant category code exclusion rule. Therefore, a merchant associated with a predetermined merchant category code (e.g., a healthcare code) is excluded from providing an offer.

In some embodiments, the account information comprises a transaction history associated with the user's financial institution account. The transaction history includes the types of transactions, frequency of transactions, amount of each transaction, merchants associated with transactions, account balance history, etc. Additionally or alternatively, the account information may or may not comprise information associated with incorrect, inconsistent, incomplete, or corrupted transactions. As used herein, a transaction may comprise a purchase, a deposit, a withdrawal, a credit, a debit, etc.

In some embodiments, the user information comprises other information as well. For example, in some embodiments, the user information comprises personal information (e.g., demographic information, salary information, contact information (mailing address, email address, phone number, etc.), residence address history, education information, job profile information, etc.) associated with the user. In some embodiments, the personal information further comprises social network information associated with the user's social network account or other non-account related information associated with the user. In some embodiments, the user information further comprises user information (e.g., personal information, account information, etc.) associated with the user's immediate or extended family members or contacts (e.g., as determined from social network information).

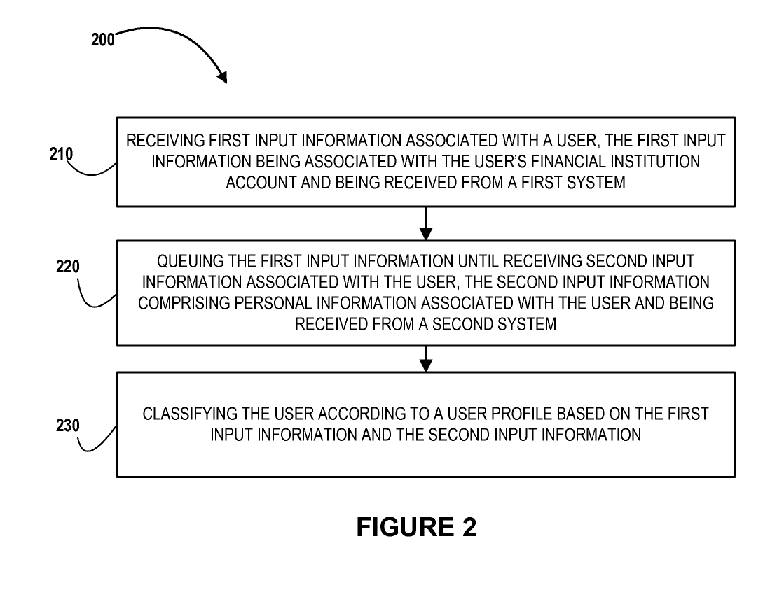

Referring now to FIG. 2, a general process flow 200 is provided for queuing input information for performing rule-based offer association. The input information may include various types of information associated with a user. For example, the input information may include account information associated with the user's financial institution account and personal information associated with the user or the user's financial institution account. In some embodiments, the input information may include information received from external systems (e.g., systems not managed by the financial institution that manages the user's financial institution account). For example, the input information may include social network information associated with the user's social network account. Therefore, each type of input information is queued on a single queue (or multiple queues) until enough input information is received to classify the user based on one or more predetermined user profiles as described below. The invention is not limited to any duration of time that the input information spends on a queue.

At block 210, the method comprises receiving first input information associated with a user, the first input information being associated with the user's financial institution account and being received from a first system. At block 220, the method comprises queuing the first input information until receiving second input information associated with the user, the second input information comprising personal information associated with the user and being received from a second system. At block 230, the method comprises classifying the user according to a user profile based on the first input information and the second input information.

The first system is separate from the second system. In some embodiments, the first system and the second system may be managed by different entities. For example, the first system is managed by a financial institution that manages the user's financial institution account, and the second system is managed by an external entity that provides personal information regarding the user to the financial institution.

In alternate embodiments, the second input information, in addition to or instead of comprising personal information associated with the user and being received from a second system, comprises information associated with the user's financial institution account and is received from a third system that is managed by the financial institution. The third system is distinct from both the first and second systems, and the account information received from the third system is different from the account information received from the first system. For example, the account information received from the first system comprises the transaction history for a predetermined period of time (e.g., the previous three months), and the account information received from the third system comprises information regarding bill payment history associated with bills being paid from funds associated with the user's financial institution account. Alternatively, the account information received from the third system comprises information regarding mortgage payments associated with a mortgage loan provided by one of the financial institution that manages the user's financial institution account or a different financial institution. Alternatively, the account information received from the third system comprises the user's status. In some embodiments, the status may indicate whether the user is eligible to receive offers associated with particular purchases (either a past purchase or a future purchase) or particular merchants. In some embodiments, the status may indicate the standing of the user's financial institution account.

In other alternate embodiments, the first input information comprises personal information associated with the user that is received from the second system. This first input information is queued until second input information associated with the user's financial institution account is received from the first system.

In some embodiments, the process flow 200 further comprises receiving at least one rule; the at least one rule comprising at least one of a user exclusion rule or a merchant exclusion rule. In some embodiments, the process flow 200 further comprises determining whether to send an offer to the user based on the at least one rule and based on the received first input information and second input information, the offer enabling the user to receive at least one of a discount or a rebate on a purchase from a merchant.

In some embodiments, the first input information comprises a transaction history associated with the user's financial institution account. In some embodiments as described herein, the transaction history may be associated with a predetermined time period (e.g., the previous three months). The transaction history includes the types of transactions, frequency of transactions, amount of each transaction, merchants associated with transactions, account balance history, etc. Additionally or alternatively, the account information may or may not comprise information associated with incorrect, inconsistent, incomplete, or corrupted transactions. As used herein, a transaction may comprise a purchase, a deposit, a withdrawal, a credit, a debit, etc.

In some embodiments, the second input information (e.g., personal information) comprises demographic information, salary information, contact information (mailing address, email address, phone number, etc.), residence address history, social network information, education information, job profile information, etc. In some embodiments, the second input information may also comprise personal information or account information associated with the user's immediate or extended family members or contacts (e.g., as determined from social network information).

In some embodiments, the user profile comprises a collection of users that are associated with similar characteristics. These characteristics may relate to the users' account transactional behavior (e.g., types of transactions, frequency of transactions, amount of each transaction, merchants associated with transactions, account balance history, etc.). As used herein, a transaction may comprise a purchase, a deposit, a withdrawal, a credit, a debit, etc. Additionally or alternatively, these characteristics may relate to the users' personal characteristics (e.g., demographic information, salary information, location information, social network information, education information, job profile information, etc.).

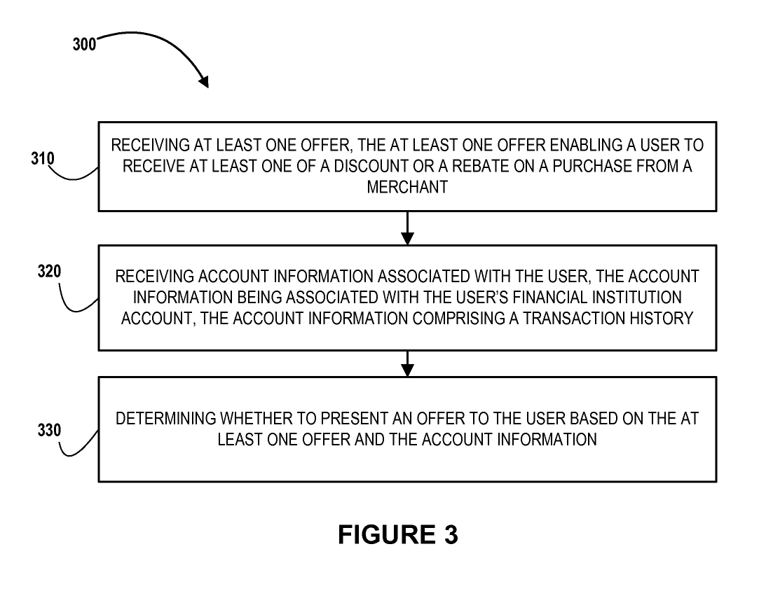

Referring now to FIG. 3, a general process flow 300 is provided for implementing an intelligent offer tool. At block 310, the method comprises receiving at least one offer, the at least one offer enabling a user to receive at least one of a discount or a rebate on a purchase from a merchant. At block 320, the method comprises receiving account information associated with the user, the account information being associated with the user's financial institution account, the account information comprising a transaction history. At block 330, the method comprises determining whether to present an offer to the user based on the at least one offer and the account information. Therefore, the determining step comprises matching an offer to an account (e.g., based on the account information) such that there is a high likelihood (e.g., greater than a threshold probability) that the user associated with the account uses the offer to make a purchase using a payment method associated with the account.

In some embodiments, at block 320, the method further comprises receiving user information associated with the user. The user information includes both account information and personal information associated with the user as described previously with respect to FIGS. 1 and 2. In such embodiments, at block 330, the method comprises determining whether to present an offer to the user based on the at least one offer and the user information.

In some embodiments, the process flow 300 further comprises determining, from the transaction history, whether to exclude a transaction, the excluded transaction being associated with at least one of incorrect, inconsistent, incomplete, or corrupted merchant information or incorrect, inconsistent, incomplete, or corrupted transaction information. Therefore, if a merchant no longer exists, transactions associated with that merchant are excluded. Additionally, if there were inconsistencies in the transaction or merchant information between when the transaction was executed (i.e., when the purchase was made) and when the transaction was processed by the financial institution, such a transaction is excluded as well. Additionally, in some embodiments, an excluded transaction may be a transaction disputed by at least one of the user or the merchant. Excluded transactions are excluded from the process of determining whether to present an offer to a user.

In some embodiments, the system does not exclude a transaction. Instead, the system intelligently determines whether transactions have been incorrectly keyed-in or whether transactions comprise incorrect merchant information. For example, the system intelligently determines that a merchant's name has changed (e.g., from Merchant ‘A’ to Merchant ‘B’), and considers transactions associated with both Merchant ‘A’ and Merchant ‘B’ as being associated with the same merchant. As a further example, the system may determine that a transaction is only partially complete (e.g., missing merchant information or price information, etc.). In such an instance, the system may determine that available information associated with the partially complete transaction is similar to one or more other transactions in the transaction history. In such an instance, the system may add information to the partially complete transaction based on the one or more similar transactions or based on other information provided to the system. As a further example, the system may determine that a transaction may have incorrect information (e.g., a price that is too high or too low, a merchant's name spelled incorrectly, etc.). In such an instance, the system may determine that information associated with the inconsistent or incorrect transaction is similar to one or more other transactions in the transaction history. In such an instance, the system may rectify the inconsistent or incorrect transaction based on the one or more similar transactions or based on other information provided to the system.

In some embodiments, the presented offer is associated with a selected payment method. Exemplary payment methods include paying via a credit card, debit card, personal check, mobile device, etc. The exemplary payment methods are not limited to those described herein. In some embodiments, the payment method is selected by at least one of the financial institution, the merchant, or the user.

In some embodiments, the offer is presented via at least one of a user interface associated with the user's financial institution account (e.g., online banking account, mobile banking account, etc.) or a user interface associated with the user's social network account. In some embodiments, the offer is inserted into or presented alongside (e.g., on the right, left, top, bottom side of a transaction, or between multiple transactions) the transaction history that is presented on the user's online banking account or mobile banking account. Therefore, for example, if ten transactions are listed in the transaction history, the offer may be presented between the fourth and fifth transactions. In some embodiments, the offer may be related to the transaction which the offer is presented alongside (e.g., the fourth and/or fifth transaction in the above example). For example, if the fourth transaction is a purchase of item ‘A’ from merchant ‘A,’ the offer is for a purchase of item ‘A’ (e.g., from any merchant) or for a purchase from merchant ‘A’ (e.g., for any item) or for a purchase of item ‘A’ from merchant ‘A.’ Alternatively, the offer may be for a purchase of a substitute of item ‘A’ (e.g., from merchant ‘A’ or from any other merchant). In some embodiments, the offer is transmitted to the user's email account. In other embodiments, the offer is transmitted, via text message, to the user's mobile device.

In some embodiments, the presented offer is an offer to receive at least one of a discount or a rebate on at least one of a purchase previously made by the user (e.g., a previous transaction associated with the user's financial institution account), a purchase from a merchant from which the user previously made a purchase, an alternative to the purchase previously made by the user, or an alternative to the purchase from the merchant from which the user previously made a purchase. The alternative to the purchase may be determined based on transaction histories associated with a plurality of financial institution accounts.

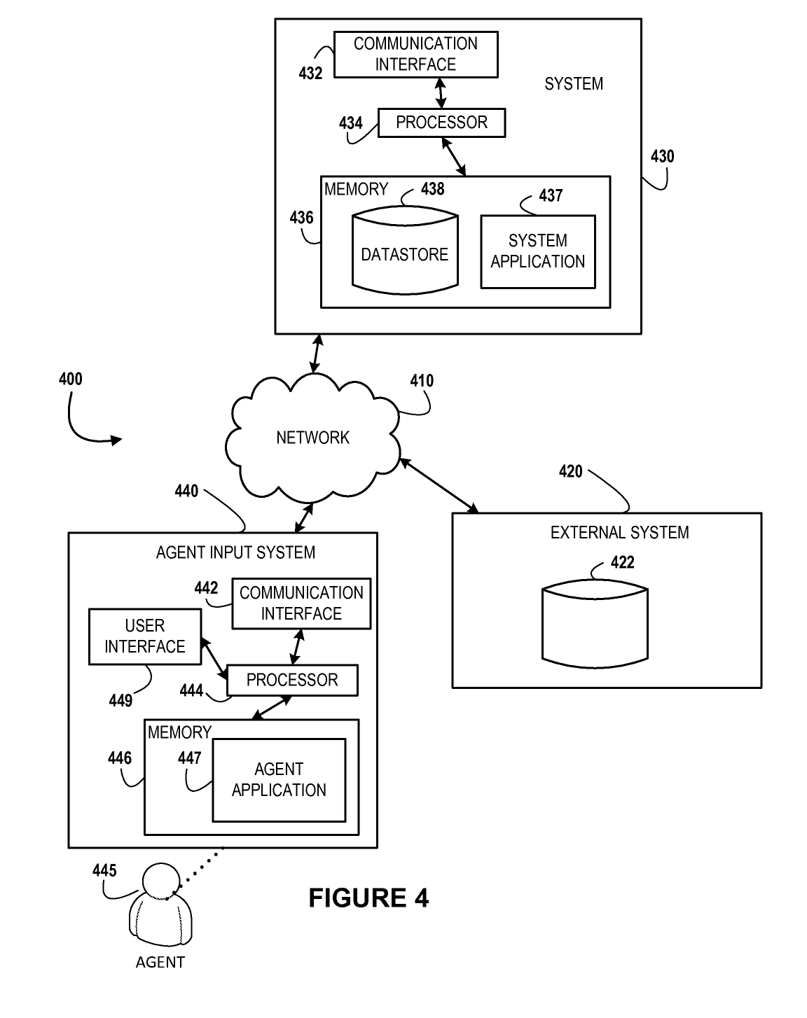

Referring now to FIG. 4, FIG. 4 presents an exemplary block diagram of the system environment 400 for implementing the process flows 100, 200, and 300, described in FIGS. 1, 2, and 3, in accordance with embodiments of the present invention. As illustrated, the system environment 400 includes a network 410, an external system 420, a system 430, and an agent input system 440. Also shown in FIG. 4 is an agent 445 of the agent input system 440. The agent 445 may be a person who uses the agent input system 440 to execute an agent application 447 or uses the agent input system 440 to initiate execution of a system application 437. The agent application 447 and/or the system application 437 may incorporate one or more parts of the process flows 100, 200, and 300. The agent may be an employee of the entity that manages the system 430 and/or the external system 420. In other embodiments, the agent may not be an employee of an entity, but may still provide a service under the direction and/or supervision of the entity.

As shown in FIG. 4, the external system 420, the system 430, and the agent input system 440 are each operatively and selectively connected to the network 410, which may include one or more separate networks. In addition, the network 410 may include a local area network (LAN), a wide area network (WAN), and/or a global area network (GAN), such as the Internet. It will also be understood that the network 410 may be secure and/or unsecure and may also include wireless and/or wireline and/or optical interconnection technology.

The external system 420 may be any computing or non-computing system that transmits information to the system 430. Additionally or alternatively, information from the system 430 may be transmitted to the external system 420. As presented in FIG. 4, the external system 420 comprises at least one datastore 422. The datastore 422 may comprise information relating to at least one of the user, the user's financial institution account, offers, rules related to targeting offers to users, personal information, etc. As used herein, the terms “data” and “information” may be used interchangeably.

The agent input system 440 may include any computerized apparatus that can be configured to perform any one or more of the functions of the agent input system 440 described and/or contemplated herein. For example, the agent 445 may use the agent input system 440 to transmit and/or receive information or commands to and from the system 430. In some embodiments, for example, the agent input system 440 may include a personal computer system, a mobile computing device, a personal digital assistant, a network device, and/or the like. As illustrated in FIG. 4, in accordance with some embodiments of the present invention, the agent input system 440 includes a communication interface 442, a processor 444, a memory 446 having an agent application 447 stored therein, and an agent interface 449. In such embodiments, the communication interface 442 is operatively and selectively connected to the processor 444, which is operatively and selectively connected to the agent interface 449 and the memory 446. In some embodiments, the agent 445 may use the agent application 447 to execute processes described with respect to the process flows described herein, or may initiate the system 430 to execute the process flows described herein.

Each communication interface described herein, including the communication interface 442, generally includes hardware, and, in some instances, software, that enables the agent input system 440, to transport, send, receive, and/or otherwise communicate information to and/or from the communication interface of one or more other systems on the network 410. For example, the communication interface 442 of the agent input system 440 may include a modem, server, electrical connection, and/or other electronic device that operatively connects the agent input system 440 to another system such as the system 430.

Each processor described herein, including the processor 444, generally includes circuitry for implementing the audio, visual, and/or logic functions of the agent input system 440. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the agent application 447 of the memory 446 of the agent input system 440.

Each memory device described herein, including the memory 446 for storing the agent application 447 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 446 includes the agent application 447. In some embodiments, the agent application 447 includes an interface for communicating with, navigating, controlling, configuring, and/or using at least one of the system 430 or the agent input system 440. In some embodiments, the agent application 447 includes computer-executable program code portions for instructing the processor 444 to perform one or more of the functions of the agent application 447 described and/or contemplated herein. In some embodiments, the agent application 447 may include and/or use one or more network and/or system communication protocols.

Also shown in FIG. 4 is the user interface 449. In some embodiments, the user interface 449 includes one or more output devices, such as a display and/or speaker, for presenting information to the agent 445. In some embodiments, the user interface 449 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the agent 445. In some embodiments, the user interface 449 includes the input and display devices of a personal computer, such as a keyboard and monitor, which are operable to receive and display information.

FIG. 4 also illustrates a system 430, in accordance with an embodiment of the present invention. The system 430 may include any computerized apparatus that can be configured to perform any one or more of the functions of the system 430 described and/or contemplated herein. In accordance with some embodiments, for example, the system 430 may include a computer network, an engine, a platform, a server, a database system, a front end system, a back end system, a personal computer system, and/or the like. In some embodiments, such as the one illustrated in FIG. 4, the system 430 includes a communication interface 432, a processor 434, and a memory 436, which includes a system application 437 and a datastore 438 stored therein. As shown, the communication interface 432 is operatively and selectively connected to the processor 434, which is operatively and selectively connected to the memory 436.

It will be understood that the system application 437 may be configured to implement any one or more portions of the various user interfaces and/or process flow described herein. It will also be understood that, in some embodiments, the memory includes other applications. It will also be understood that, in some embodiments, the system application 437 is configured to communicate with the datastore 438, the agent input system 440 and/or the external system 420.

It will be further understood that, in some embodiments, the system application 437 includes computer-executable program code portions for instructing the processor 434 to perform any one or more of the functions of the system application 437 described and/or contemplated herein. In some embodiments, the system application 437 may include and/or use one or more network and/or system communication protocols.

In addition to the system application 437, the memory 436 also includes the datastore 438. As used herein, the datastore 438 may be one or more distinct and/or remote datastores. In some embodiments, the datastore 438 is not located within the system and is instead located remotely from the system. In some embodiments, the datastore 438 stores information or data described herein. For example, the datastore 438 may store information relating to at least one of the user, the user's financial institution account, offers, rules related to targeting offers to users, personal information, etc.

It will be understood that the datastore 438 may include any one or more storage devices, including, but not limited to, datastores, databases, and/or any of the other storage devices typically associated with a computer system. It will also be understood that the datastore 438 may store information in any known way, such as, for example, by using one or more computer codes and/or languages, alphanumeric character strings, data sets, figures, tables, charts, links, documents, and/or the like. Further, in some embodiments, the datastore 438 may include information associated with one or more applications, such as, for example, the system application 437. It will also be understood that, in some embodiments, the datastore 438 provides a substantially real-time representation of the information stored therein, so that, for example, when the processor 434 accesses the datastore 438, the information stored therein is current or substantially current.

It will be understood that the embodiment of the system environment illustrated in FIG. 4 is exemplary and that other embodiments may vary. As another example, in some embodiments, the system 430 includes more, less, or different components. As another example, in some embodiments, some or all of the portions of the system environment 400 may be combined into a single portion. Likewise, in some embodiments, some or all of the portions of the system 430 may be separated into two or more distinct portions.

In addition, the various portions of the system environment 400 may be maintained for and/or by the same or separate parties. For example, the system 430 and the external system 420 may be maintained by separate parties.

It will also be understood that the system 430 may include and/or implement any embodiment of the present invention described and/or contemplated herein. For example, in some embodiments, the system 430 is configured to implement any one or more of the embodiments of the process flow 100, 200, 300 and 500 described and/or contemplated herein in connection with FIG. 1, 2, 3, 5 or any other process flow described herein.

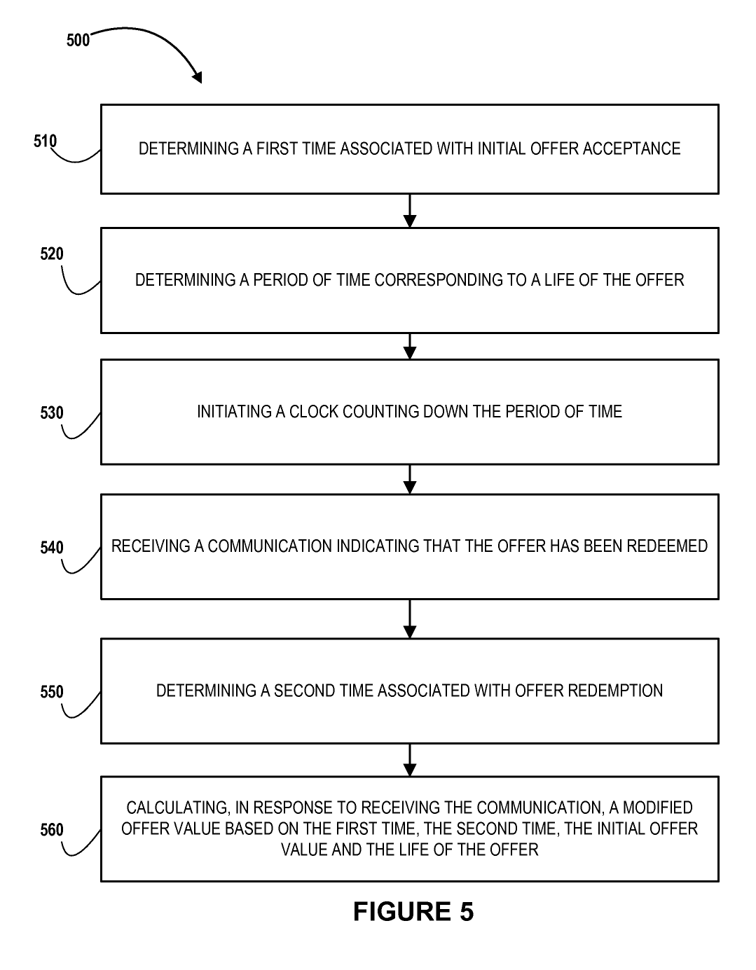

In other embodiments of the invention, systems, methods and computer program products for modifying an offer are provided. In various embodiments, the offer has an initial offer value including the steps of determining a first time associated with initial offer acceptance, determining a period of time corresponding to a life of the offer, initiating a clock counting down the period of time, receiving a communication indicated that the offer has been redeemed, determining a second time associated with offer redemption, and calculating, in response to receiving the communication, a modified offer value based on the first time, the second time, the initial offer value and the life of the offer. In some embodiments, one or more of the steps described with reference to FIG. 5 are eliminated or modified in some fashion.

Referring now to FIG. 5, a flowchart illustrates a method 500 for modifying offers based on circumstances associated with the offers. The first step is to determine a first time associated with initial offer acceptance. The next step is to determine a period of time corresponding to a life of the offer. In some embodiments, the next step is to initiate a clock counting down the period of time. The next step is to receive a communication indicated that the offer has been redeemed. The next step is determining a second time associated with offer redemption. The final step is calculating, in response to receiving the communication, a modified offer value based on the first time, the second time, the initial offer value and the life of the offer.

The first step, determining a first time associated with initial offer acceptance, represented by block 510, may refer to a user being made aware of the offer, such as through an electronic transmission of the offer. Such transmission may be via text message, email, other electronic message, via an online banking interface or website, via other website, or the like. For example, the offer may be presented in-line with transaction history of such that it is next to a transaction to which it relates as discussed further above.

The next step, at block 520, is determining a period of time corresponding to a life of the offer. This period of time may be predetermined by the entity to which the offer applies, may be predetermined by a financial institution that is facilitating delivery and redemption of the offer or otherwise. In some embodiments, the period of time for the offer may also be correlated to the value of the offer. For example, an offer may be presented to a user for use at a merchant. The offer may be for 20% off the purchase of any item and may have an associated period of time corresponding to the life of the offer of 20 days (or 20 weeks or some other period of time). In this example, the value of the offer is tied to the period of time remaining, such that the value of the offer decreases as the time expires. In one example, the value of the offer is based on the number of days left for the offer. For example, if there are 15 days left on the offer, then the value of the offer may be 15% off any item sold by the merchant. In this regard, the user has an incentive to redeem the offer quickly in order to attain the highest value of the offer available.

The next step, at block 530, is initiating a clock counting down the period of time. This clock may be based on data or metadata that is associated with the offer. For example, the offer may be a software module or packet of data that is stored locally at a merchant or financial institution server and is accessed when a user selects the offer. The clock may be a mechanism internal to the offer packet such that when the offer is accessed it may communicate how much time is left for the offer, the value of the offer, the relationship between the remaining time period and the value of the offer and/or any other information relevant to the offer. In other embodiments, information related to the offer is stored in more than one location. In some embodiments, the offer presentation may simply be a link to information regarding the offer, and the substance of the offer, that is, the time remaining in the offer as well as the value of the offer, may be changed by one or more entities. For example, the time remaining and the value of the offer may be changed by the merchant associated with the offer or the financial institution or other entity enabling presentation and redemption of the offer.

The offer may be activated, for example, by a user selecting the offer from a group of offers available to the user in an offer dashboard. In some embodiments, one or more available offers may be presented to the user via the user's online banking webpage or interface such that the user may select the offers to become active. Once the user has selected the offer(s) to become active, the offer's clock may begin running (see step 530).

The next step, at block 540, is receiving a communication indicating that the offer has been redeemed. Once the offer has been activated, if necessary for the specific offer, then the offer may be redeemed. Redemption may happen a number of ways. For example, the offer may be redeemed by a user purchasing a product or performing a transaction at a merchant that is associated with the offer. The offer may automatically be applied by the financial institution who is facilitating the offer for the merchant or product seller. In this regard, the user may not have to carry an offer card or other proof of offer, and therefore, the user may avoid alerting the merchant to the intention to redeem the offer. As discussed above, the user may redeem the offer simply by performing a transaction at the merchant associated with the offer once the user has activated the offer. Then, in some embodiments, the offer is credited to the user's account at the end of a billing cycle, for example.

The next step, at block 550, is determining a second time associated with offer redemption. In some embodiments, the offer includes a timestamp that is used in determining the value of the offer at the time of redemption. For example, an offer that has not been activated may provide an opportunity to receive 30% off a transaction with Merchant A. The offer is tailored to be modified over time based on a relationship between the amount of time that has transpired after activation of the offer, and in some embodiments, the offer expires completely after a predetermined period of time. Thus, the time at which the offer is activated, which may correlate with the time of initiating a clock regarding the offer, is used in combination with the time that an offer is redeemed to calculate the value of the offer at the time it is redeemed.

The next step, at block 560, is calculating, in response to receiving the communication, a modified offer value based on the first time, the second time, the initial offer value and the life of the offer. For example, a processing device may calculate the modified offer value associated with the offer based on the initial offer value and the elapsed period of time since the clock was initiated. As a specific example, for an offer than was activated with an initial offer value of 20% and that decreased in value one percent every day until it was redeemed five days after activation, the processing device would calculate that the offer, at the time of redemption was valued at 15% rather than the initial value of 20%. Accordingly, in some embodiments, when the modified offer value is applied or credited to the user's account at the end of the billing cycle, for example, the modified offer value of 15% will be used to credit the transaction.

In various embodiments, existing offers may be modified such that, when the offers are redeemed, the user does not know the exact amount of the offer. For example, the merchant associated with the offer and/or the financial institution implementing the redemption and crediting of the offer amount may individually, or in collaboration, alter the value of the offer based on one or more of a variety of factors. For example, the offer may be modified based on how many offers the user has activated in a given time period, how many offers, the user has redeemed in a given time period, how many offers the user has activated and/or redeemed associated with one or more merchants and/or using one or more financial institution accounts within a given time period or throughout the life of the user's offer program account or other account(s).

In some embodiments, the offer may be modified based on one or more other criteria, such as the geographic area in which the transaction occurred. For example, the offer may be worth a different value depending on the location is it redeemed. In some embodiments, the offer may be modified such that the value of the offer increases as time goes on. In some embodiments, once an offer is presented to a user as a possible offer, the offer is considered “activated” and does not require a positive step or input from the user in order for the offer to be “activated”. Accordingly, such offers than are then modified based on a clock that begins running upon activation, or the equivalent, are dependent not on a positive activation action of the customer, but rather, on the time that the offer was first presented to the customer.

In some embodiments, such as those where an offer has a clock that is associated with the offer's modified value, one or more communications may be sent to the customer indicating to the customer a new modified value of the offer. Such communications may be over text message, email, via online banking website or otherwise. In this regard, the customer may remain apprised of the current (or recent) value of the offer, and therefore, may be able to make a decision regarding whether to redeem the offer and/or allow the offer to expire.

In some embodiments, the customer is given an opportunity to receive an additional offer in conjunction with redemption of an existing offer. In this way, the existing offer may be “modified” such that the value of the existing offer includes the additional offer. Thus, a time limit may be placed on the existing offer, for example, such that the additional offer may be received, activated or otherwise associated with the customer, upon redemption of the existing offer if the customer redeems the existing offer within the time period. In some such embodiments, the value of the additional offer may be based on the time period for redemption of the existing offer. For example, a communication may be sent to a customer indicating that if the customer redeems the existing offer within the next 24 hours, that an additional offer will be provided to the customer that will afford the customer an opportunity to make an additional purchase at the same (or a different) merchant and receive a certain percentage off the purchase price. For illustration purposes, if that percentage is 15% off, then, once the 24 hour period expires, the offer may then be reduced in value or may completely expire. In this regard, a future, potential offer may be modified based on activation and/or redemption of an existing offer.

In some embodiments, instead of or in conjunction with modification of an offer based on a countdown or elapsed time from a specific start time, the offer may be modified in other ways. The offer may be modified based on the time of day, week, month, year, etc. that the offer is activated or redeemed. The offer may be redeemed within a predetermined window of time during a day. The predetermined period of time of day may be associated with a specific modified offer value or factors or criteria that affect the modified offer value calculated using other, additional criteria. For example, during the hours of 7:00 AM to 9:00 AM, Merchant A may provide a discount of 25% on a category of products corresponding with the offer, whereas during all other times of day, Merchant A provides a lower discount of 10% for the category of products corresponding with the offer. In various embodiments, different modified offer values may correspond with various windows throughout a time period such as a day.

In some embodiments, an offer is presented to a user or allowed to be activated by a user or both upon the user completing some predefined task. Such a task may be issuing a social media message or otherwise communicating or publicizing a particular message or content. The system may be configured to detect certain words or phrases or other content from certain users, for example, those users who have accounts maintained by a particular financial institution, and if a user issue or publishes the required content, then the system may present an offer to the customer. In some embodiments, the user already has an existing offer available to the user, and if the user communicates the required content, the offer will be modified. In this way, the system may incent users to publicize certain content in exchange for new offers.

In various embodiments, an offer may be presented and/or modified when a user signs out or logs off of an online banking website. In some embodiments, a previously presented offer or offer that is presented at sign out is timed out as discussed herein or otherwise after the user signs out. In other embodiments, the system may push an offer to the user prior to the actual sign out. For example, when the user selects an option to sign out, a screen may be presented prior to a sign out confirmation screen presenting an offer to the user and/or modifying one or more offers previously accepted by the user. In some embodiments, the user is not exiting an online banking environment, but rather, is exiting some other secure environment and entering a non-secure environment. The one or more offers may be presented upon the user expressing intent to exit the secure environment and/or upon the user confirming that the user desires to exit the secure environment. In some embodiments, a new offer may be presented and/or an existing offer may be modified when a user enters a secure environment from a non-secure environment.

In some embodiments, the system determines that a user has accepted an offer associated with a merchant in a specific market or category. The system may determine that the user has visited a competitor to the merchant in the specific market or category and, in response to this determination, modify the accepted offer in some fashion. For example, the system may increase the value of the offer in order to entice the user to redeem the accepted offer at the merchant rather than the merchant's competitor. In another example, the system may decrease the value of the offer in order to entice the user to redeem the accepted offer at the merchant instead of visiting the merchant's competitor. In some embodiments, the new value of the offer may be communicated to the user so that the user can visualize the correlation between visiting a competitor and the change in the value of the offer. In some embodiments, a communication may be sent to the user before the user visits a competitor. For example, when the offer is first accepted by the user, the system may communicate that the offer is subject to change if the user performs a transaction with a competitor. In other embodiments, a second offer may be available to the user but only if the user redeems the first offer at the merchant without visiting a competitor. In some embodiments, the new offer or modification to an accepted offer is made after the user has performed a predetermined number of transactions with a competitor. For example, if the user accepts an offer to Merchant A and then visits Merchant B five (5) times, then the offer for Merchant A may change in value (up or down) or may expire. In some embodiments, each visit and/or transaction performed with a competing merchant triggers a change in the value of the offer. For example, if a user visits a competitor twice, then the offer may be reduced by 5% with each individual transaction with the competitor.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for modifying an offer having an initial offer value, comprising:
a processing device;
a computer-readable memory storing computer-executable instruction code to cause the processing device to:
present the offer on a display to a user logged into an online banking website, comprising presenting the offer in between two entries in a transaction history of the user;
receive user input selecting the offer, thereby indicating initial offer activation;
determine a first time associated with initial offer activation;
determine a period of time corresponding to a life of the offer;
initiate a clock counting down the period of time;
receive a communication indicating that the offer has been redeemed;
determine a second time associated with offer redemption; and
calculate, in response to receiving the communication, a modified offer value based on the first time, the second time, the initial offer value and the life of the offer.

2. The system of claim 1, wherein the instruction code is further structured to cause the processing device to:
credit a user's account used in a transaction wherein the offer was redeemed, the crediting based at least in part on the calculated modified offer value.

3. The system of claim 1, wherein the instruction code is further structured to cause the processing device to:
receive input from a user activating the offer, thereby initiating the clock counting down the period of time and wherein the first time associated with initial offer acceptance is based at least in part on the activation of the offer.

4. The system of claim 1, wherein the instruction code is further structured to cause the processor to:
initiate a communication to the user to inform the user of the modified offer value.

5. The system of claim 1, wherein the modified offer value comprises a value of one or more additional offers.

6. The system of claim 1, wherein the instruction code is further structured to cause the processor to:
determine that the user has performed a predetermined social media task; and
present the user with the offer for potential acceptance and redemption.

7. The system of claim 1, wherein the instruction code is further structured to cause the processor to:
determine that the second time associated with offer redemption falls within a predetermined window of time associated with a special offer value; and
calculate, in response to receiving the communication that the offer has been redeemed, the modified offer value based at least in part on the special offer value.

8. A computer program product for modifying an offer having an initial offer value, the computer program product comprising a non-transitory computer-readable medium comprising instructions, the instructions comprising:
instructions for presenting the offer on a display to a user logged into an online banking website, comprising presenting the offer in between two entries in a transaction history of the user;
instructions for receiving user input selecting the offer, thereby indicating initial offer activation;
instructions for determining a first time associated with initial offer activation;
instructions for determining a period of time corresponding to a life of the offer;
instructions for initiating a clock counting down the period of time;
instructions for receiving a communication indicating that the offer has been redeemed;
instructions for determining a second time associated with offer redemption; and
instructions for calculating, in response to receiving the communication, a modified offer value based on the first time, the second time, the initial offer value and the life of the offer.

9. The computer program product of claim 8, wherein the instructions further comprise:
instructions for crediting a user's account used in a transaction wherein the offer was redeemed, the crediting based at least in part on the calculated modified offer value.

10. The computer program product of claim 8, wherein the instructions further comprise:
instructions for receiving input from a user activating the offer, thereby initiating the clock counting down the period of time and wherein the first time associated with initial offer acceptance is based at least in part on the activation of the offer.

11. The computer program product of claim 8, wherein the instructions further comprise:
instructions for initiating a communication to the user to inform the user of the modified offer value.

12. The computer program product of claim 8, wherein the modified offer value comprises a value of one or more additional offers.

13. The computer program product of claim 8, wherein the instructions further comprise:
instructions for determining that the user has performed a predetermined social media task; and
instructions for presenting the user with the offer for potential acceptance and redemption.

14. The computer program product of claim 8, wherein the instructions further comprise:
instructions for determining that the second time associated with offer redemption falls within a predetermined window of time associated with a special offer value; and
instructions for calculating, in response to receiving the communication that the offer has been redeemed, the modified offer value based at least in part on the special offer value.

15. A method for modifying an offer having an initial offer value, comprising:
presenting, using a processing device, the offer on a display to a user logged into an online banking website, comprising presenting the offer in between two entries in a transaction history of the user;
receiving user input selecting the offer, thereby indicating initial offer activation;
determining, using a processing device, a first time associated with initial offer activation;
determining, using a processing device, a period of time corresponding to a life of the offer;
initiating, using a processing device, a clock counting down the period of time;
receiving a communication indicating that the offer has been redeemed;
determining a second time associated with offer redemption; and
calculating, in response to receiving the communication and using a processing device, a modified offer value based on the first time, the second time, the initial offer value and the life of the offer.

16. The method of claim 15, further comprising:
crediting a user's account used in a transaction wherein the offer was redeemed, the crediting based at least in part on the calculated modified offer value.

17. The method of claim 15, further comprising:
receiving input from a user activating the offer, thereby initiating the clock counting down the period of time and wherein the first time associated with initial offer acceptance is based at least in part on the activation of the offer.

18. The method of claim 15, further comprising:
initiating a communication to the user to inform the user of the modified offer value.

19. The method of claim 15, further comprising:
determining that the user has performed a predetermined social media task; and
presenting the user with the offer for potential acceptance and redemption.

20. The method of claim 15, further comprising:
determining that the second time associated with offer redemption falls within a predetermined window of time associated with a special offer value; and
calculating, in response to receiving the communication that the offer has been redeemed, the modified offer value based at least in part on the special offer value.
